(19) United States
(12) Patent Application Publication
(10) Pub. No.: US 2011/0157325 A1
(43) Pub. Date: Jun. 30, 2011

(54) VIDEO DISPLAY APPARATUS

(75) Inventor: Kei Tanaka, Ome-shi (JP)

(73) Assignee: Kabushiki Kaisha Toshiba, Tokyo (JP)

(21) Appl. No.: 12/975,889

(22) Filed: Dec. 22, 2010

(30) Foreign Application Priority Data
Dec. 25, 2009 (JP) 2009-295625

(51) Int. Cl. H04N 13/04; G06K 9/00

(52) U.S. Cl. 348/51; 382/103; 348/E13.075

(57) ABSTRACT

According to one embodiment, a video display apparatus includes a display device, a camera, a detection module, a determination module, and a message display module. The camera is configured to capture an image in front of the display device. The detection module is configured to detect a position of glasses in the image. The determination module is configured to determine a relative relationship between the position detected by the detection module and a predetermined reference position. The message display module is configured to display a message corresponding to the relative relationship on the display device.

### CROSS-REFERENCE TO RELATED APPLICATIONS

This application is based upon and claims the benefit of priority from Japanese Patent Application No. 2009-295625, filed Dec. 25, 2009; the entire contents of which are incorporated herein by reference.

### FIELD

Embodiments described herein relate generally to a video display apparatus which can display three-dimensional (3D) video.

### BACKGROUND

Conventionally, there is known a stereoscopic image display apparatus which displays a more natural stereoscopic (3D) image by displaying a parallax image according to an inclination of glasses.

Jpn. Pat. Appln. KOKAI Publication No. 2006-084963 discloses a stereoscopic image display apparatus which detects an inclination of glasses and generates and displays a parallax image in accordance with the detection result. Thus, even in the case where the viewer leans the head, it is possible to display a proper parallax image according to the movement of the head, and to display a more natural stereoscopic image.

In the above prior art, a natural stereoscopic image is displayed by detecting the inclination of glasses and generating a parallax image according to the detected inclination. Consequently, even when a long moving picture, such as a cinema, is displayed, it is necessary to continuously detect the inclination of the glasses while the moving picture is being displayed, and to execute an image process for generating a parallax image according to the detected inclination. In short, in order to enable the user to view a natural stereoscopic image, a large load of image processing is required. Therefore, there has been a demand for a video display apparatus which enables the user to view optimal 3D video more easily, with a less load of image processing.

### BRIEF DESCRIPTION OF THE DRAWINGS

A general architecture that implements the various feature of the embodiments will now be described with reference to the drawings. The drawings and the associated descriptions are provided to illustrate the embodiments and not to limit the scope of the invention.

FIG. 1 is a perspective view showing an example of an opened personal computer according to an embodiment;

FIG. 2 is an block diagram showing an example system configuration of a personal computer according to an embodiment;

FIG. 3 is a flow chart illustrating a 3D glasses registration process in an embodiment;

FIG. 4 is a view showing a relative positioning of a personal computer and a 3D glasses during a 3D glasses registration process in an embodiment;

FIG. 5 is a view showing a part, corresponding to the 3D glasses, in an image which is captured by a camera in an embodiment;

FIG. 6 is a flow chart illustrating an example position adjustment process of an embodiment;

FIG. 7 is a view of a captured image including the 3D glasses in an embodiment; and

FIG. 8 is a view showing an example message display in an embodiment.

### DETAILED DESCRIPTION

Various embodiments will be described hereinafter with reference to the accompanying drawings.

In general, according to one embodiment, a video display apparatus comprises a display device, a camera, a detection module, a determination module, and a message display module. The camera is configured to capture an image in front of the display device. The detection module is configured to detect a position of glasses in the image. The determination module is configured to determine a relative relationship between the position detected by the detection module and a predetermined reference position. The message display module is configured to display a message corresponding to the relative relationship on the display device.

An embodiment will now be described with reference to the accompanying drawings.

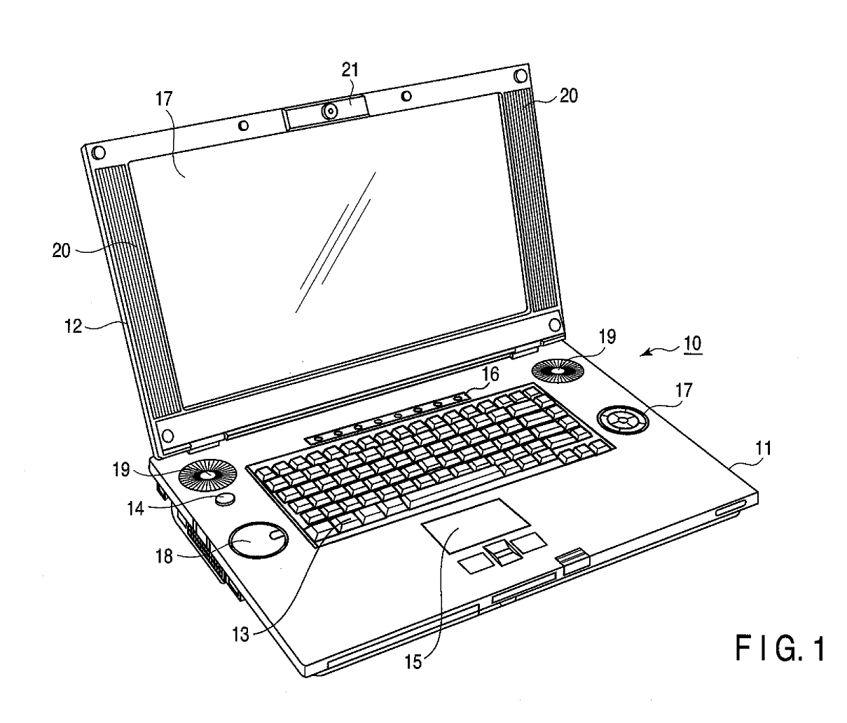

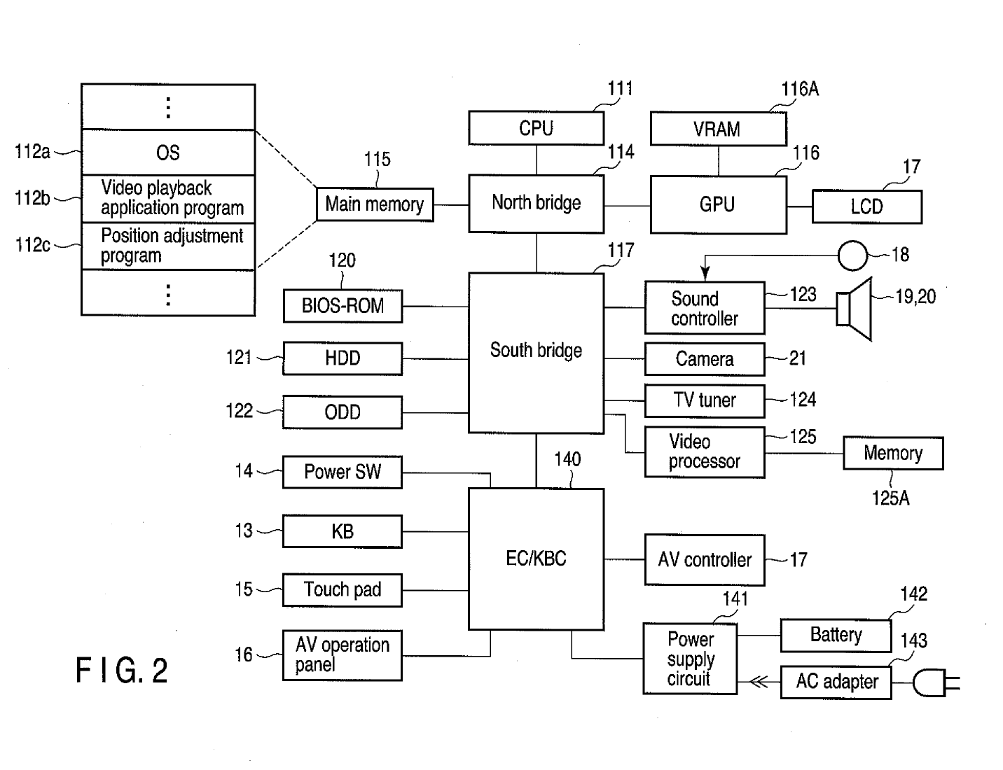

To begin with, referring to FIG. 1 and FIG. 2, the structure of a video display apparatus according to the embodiment is described. The video display apparatus is realized, for example, as a notebook personal computer 10. The video display apparatus may be realized not only by the personal computer 10, but also by other video display apparatuses such as a television apparatus.

FIG. 1 is a perspective view that shows the state in which a display unit of the notebook personal computer 10 is opened. The computer 10 comprises a computer main body 11 and a display unit 12. A display device that is composed of an LCD (Liquid Crystal Display) 17 is built in the display unit 12. The display screen of the LCD 17 is positioned at an approximately central part of the display unit 12. Speakers (tweeters) 20 are disposed on both sides of the LCD 17.

The display unit 12 is attached to the computer main body 11 such that the display unit 12 is freely rotatable between an open position and a closed position. A keyboard 13, a power button 14 for power on/off, a touch pad 15, an audio/video (AV) operation panel 16, an AV controller 17, a volume control dial 18 and speakers 19 are disposed on the top surface of the casing of the computer main body 11. A camera 21, which can capture a color image, is provided on the display unit 12 at an upper side portion thereof in the open position of the display unit 12. The camera 21 is configured to capture an image just in front of the display unit 12, and the camera 21 can capture an image in a range including at least the face of the user who is viewing the video displayed on the personal computer 10. Specifically, the camera 21 is configured to be able to capture an image of 3D glasses which are worn by the user in order to view three-dimensional (3D) video content which is displayed on the display unit 12.

Next, referring to FIG. 2, the system configuration of the personal computer 10 is described.

The computer 10 includes a CPU 111, a north bridge 114, a main memory 115, a graphics processing unit (GPU) 116, a south bridge 117, a BIOS-ROM 120, a hard disk drive (HDD) 121, an optical disc drive (ODD) 122, a sound controller 123, a TV tuner 124, a video processor 125, an embedded controller/keyboard controller IC (EC/KBC) 140, and a power supply circuit 141.

The CPU 111 is a processor that is provided for controlling the operation of the computer 10. The CPU 111 executes an operating system (OS) 112a and various application programs, which are loaded from the HDD 121 into the main memory 115, and a BIOS (Basic Input/Output System) which is stored in the BIOS-ROM 120. The application programs include a video playback program 112b and a position adjustment program 112c.

The video playback program 112b is an application which can play back and output 3D video content that is recorded in recording media such as the hard disk drive (HDD) 121 and a DVD (Digital Versatile Disc). When 3D video is played back and output by the video playback program 112b, the position adjustment program 112c executes a position adjustment process for assisting the user in viewing the 3D video at an optimal position just in front of the display unit 12 (LCD 17).

The north bridge 114 is a bridge device that connects a local bus of the CPU 111 and the south bridge 117. The north bridge 114 includes a memory controller that access-controls the main memory 115. The north bridge 114 also has a function of communicating with the graphics processing unit (GPU) 116 via, e.g. a PCI Express bus.

The graphics processing unit (GPU) 116 is a display controller which controls the LCD 17 that is used as a display monitor of the computer 10. The GPU 116 generates a video signal, which forms a screen image that is to be displayed on the LCD 17, based on display data that is written in a video memory (VRAM) 116A by the OS or application program.

The south bridge 117 includes a controller for controlling the HDD 121 and optical disc drive (ODD) 122.

The HDD 121 is a storage device which stores various programs and data. For instance, the OS, various application programs and video content data are stored in the HDD 121. In addition, data of a message to the user, which is displayed on the LCD 17 in the position adjustment process by the position adjustment program 112c, is recorded in the HDD 121.

The optical disc drive (ODD) 122 is a drive unit for driving storage media, such as a DVD, in which video content is stored.

The sound controller 123 is a sound source device and executes a process for outputting sound, which corresponds to various audio data, from the speakers 19 and 20. The TV tuner 124 receives broadcast program data which is broadcast by a TV broadcast signal.

Further, the video processor 125 is connected to the south bridge 117. The video processor 125 is a dedicated engine for executing a video streaming process or a video recognition process. A memory 125A is used as a working memory of the video processor 125.

The embedded controller/keyboard controller IC (EC/KBC) 140 is a one-chip microcomputer in which an embedded controller for power management and a keyboard controller for controlling the keyboard (KB) 13, touch pad 15 and AV operation panel 16 are integrated.

The EC/KBC 140 has a function of powering on/off the computer 10 in response to the user's operation of the power button switch 14. The power on/off control of the computer 10 is executed by cooperation of the EC/KBC 140 and power supply circuit 141. The power supply circuit 141 generates operation power to the respective components by using power from a battery 142 which is attached to the computer main body 11 or power from an AC adapter 143 which is connected to the computer main body 11 as an external power supply.

Next, the operation of the personal computer 10 in the embodiment is described.

The personal computer 10 in the embodiment can play back and display 3D video content which makes use of, for example, a time-division display scheme. The 3D video content is configured such that a right-eye image and a left-eye image are alternately displayed so that the video displayed on the LCD 17 may be recognized as a stereoscopic image. By wearing glasses for 3D video recognition, the user can recognize the video, which is displayed on the LCD 17, as 3D video. It is assumed that the glasses for 3D video recognition (hereinafter referred to simply as “glasses”), which are used in the embodiment, are liquid crystal shutter glasses, for instance. The glasses are configured such that the right-eye side and the left-eye side are alternately switched between a transmissive state and a non-transmissive state in sync with switching of a right-eye image and a left-eye image of 3D video content. Thereby, the user can visually recognize the right-eye image by the right eye and the left-eye image by the left eye, thus being able to recognize video as a stereoscopic video image.

When the liquid crystal shutter glasses are used, the user can recognize 3D video in the optimal state by viewing the video from a position just in front of a central part of the display. If the user views video from a position which is displaced in an upward/downward direction or in a leftward/rightward direction from the position just in front of the central part of the display, the user could not enjoy normal 3D video.

In the personal computer 10 in the embodiment, the position adjustment program 112c detects the position (i.e. the position of the glasses) at which the user visually recognizes video. If the position adjustment program 112c determines that the user does not view 3D video at the correct position, the position adjustment program 112c outputs a message prompting the user to move to the optimal position.

The video display apparatus (personal computer 10) in the embodiment is not limited to the type in which 3D video is displayed by the time-division display scheme with use of the liquid crystal shutter glasses. The video display apparatus may be of any type using a system in which the quality of 3D video deteriorates when the 3D video is viewed from a position displaced from the optimal position.

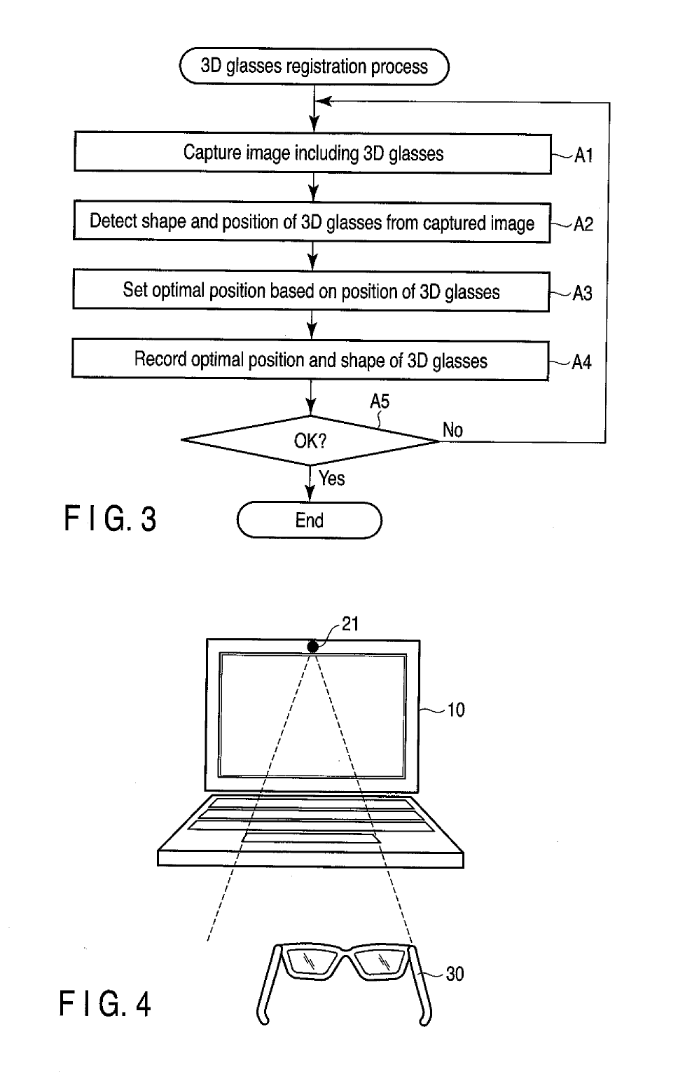

FIG. 3 is a flow chart illustrating a 3D glasses registration process in the embodiment. The 3D glasses registration process is a process for facilitating a process of detecting the glasses used by the user from an image in a position adjustment process (to be described later), and for setting an optimal position (reference position) corresponding to the environment in which the user views 3D video.

If the position adjustment program 112c is started, the CPU 111 starts the 3D glasses registration process. The user wears the glasses which are used in viewing 3D video content. After the user moves to a position where the user can view the 3D video displayed on the LCD 17 in the optimal state, the user instructs image capturing, for example, by an operation on the keyboard 13.

In usual cases, the position where 3D video can be viewed in the optimal state is a position just in front of a central part of the LCD 17. However, it is possible that the optimal position varies, for example, due to the angle of inclination of the display unit 12 at a time when 3D video is viewed, the environment of the place where the personal computer 10 is disposed (e.g. the brightness of the room), the capability of the glasses used by the user, and the difference in the display state favored by the user. Thus, the position where the user actually feels that the display state of 3D video is optimal can be registered in the 3D glasses registration process.

FIG. 4 shows the state in which the 3D glasses registration process is executed. As shown in FIG. 4, the user wearing the 3D glasses 30 instructs image capturing at a position just in front of the display unit 12 of the personal computer 10.

If the image capturing is instructed, the CPU 111 drives camera 21, thereby capturing an image (block A1). The image captured by the camera 21 includes the 3D glasses 30 worn by the user.

The CPU 111 detects, from the image captured by the camera 21, the shape (possibly including the color) of the 3D glasses 30 and the position of the 3D glasses 30 in the image (block A2).

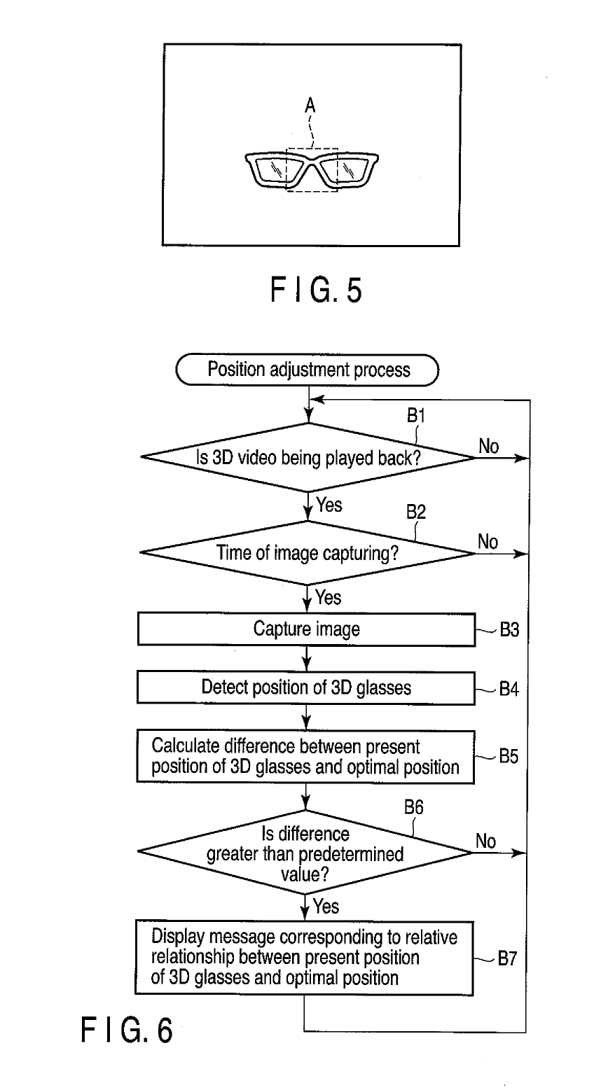

FIG. 5 shows only the part corresponding to the 3D glasses 30 in the image captured by the camera 21. Even if the user uses a plurality of kinds of 3D glasses 30, since the basic structure thereof is common, the shape and position can be detected by a known image processing method.

The CPU 111 detects a predetermined position on the image area corresponding to the 3D glasses 30 as the position of the 3D glasses 30 (block A3). In the example shown in FIG. 5, an area A of a predetermined range including the central part of the glasses, for instance, is detected as the position of the 3D glasses 30 in the image.

The CPU 111 records the data indicative of the optimal position A and the shape of the 3D glasses 30, which are detected from the image, as data which is used by the position adjustment process (block A4).

The user instructs the end of the process if the position at the time when the image capturing was instructed is the optimal position with no problem. In accordance with the instruction from the user, the CPU 111 terminates the 3D glasses registration process (Yes in block A5). It is possible to set once again the shape and optimal position of the 3D glasses 30, in the same manner as described above, by instructing image capturing (No in block A5).

In the above-described 3D glasses registration process, the optimal position, as well as the shape of the 3D glasses, is set. However, if the optimal position is set in advance by the position adjustment program 112c, the registration of the optimal position may be omitted. Besides, if the position of the 3D glasses 30 can be detected by the position adjustment process by the position adjustment program 112c (to be described later) even without registration of the 3D glasses 30 of each of users, the 3D registration process may be omitted. Whether or not to execute the 3D registration process may arbitrarily be determined by the user.

FIG. 6 is a flow chart illustrating the position adjustment process in the embodiment. The position adjustment process is executed by the position adjustment program 112c in accordance with playback of video content by the video playback program 112b.

If the playback of video content is started by the video playback program 112b, the CPU 111 determines whether a time for capturing an image has come, in order to confirm the position of the 3D glasses 30. For example, the image capturing for confirming the position of the 3D glasses 30 is executed at regular time intervals (e.g. in every several minutes).

When the time for capturing has come, the CPU 111 captures an image by the camera 21 (block B3). The camera 21 captures an image just in front of the display unit 12 (LCD 17).

The CPU 111 detects the position of the 3D glasses 30 from the image captured by the camera 21 (block B4). In this example, based on the data indicative of the shape of the 3D glasses 30, which is recorded in advance by the 3D glasses registration process, the CPU 111 recognizes the 3D glasses 30 from the image and determines the position of the 3D glasses 30. By using the data which is registered in advance by the 3D glasses registration process, the detection precision in detecting the 3D glasses 30 from the image can be enhanced, and the processing time can be shortened. As shown in FIG. 5, the position of the 3D glasses 30 is set to be the area of a predetermined range including the central part of the glasses.

The CPU 111 calculates the difference (distance) between the position of the 3D glasses 30 detected from the captured image and the preset optimal position (block B5), and determines whether the difference is greater than a predetermined reference value.

When it is determined that the difference is not greater than the reference value (No in block B6), the CPU 111 determines that the user is viewing 3D video at the optimal position, and displays no message.

On the other hand, when it is determined that the difference is greater than the reference value (Yes in block B6), the CPU 111 causes the LCD 17 to display a message corresponding to the relative relationship between the present position of the 3D glasses 30 and the optimal position (reference position) (block B7).

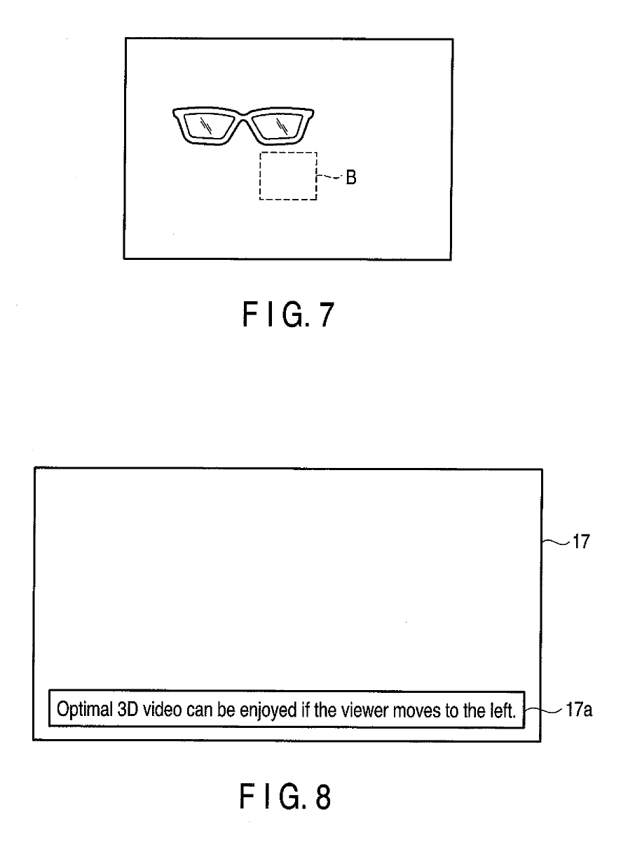

FIG. 7 shows an example of the captured image including the 3D glasses. An area B in FIG. 7 indicates the optimal position. In the example shown in FIG. 7, the area of the 3D glasses is positioned leftward relative to the optimal position (area B). Thus, based on the positional relationship between the optimal position (area B) and the 3D glasses 30, it can be determined that the position of the 3D glasses 30 becomes closer to the optimal position if the user moves leftward.

The CPU 111 specifies a message corresponding to the relative relationship between the present position of the 3D glasses 30 and the optimal position, and displays the message, for example, in a message window 17a which is set under the display area of the LCD 17, as shown in FIG. 8. For example, a message, “Optimal 3D video can be enjoyed if the viewer moves to the left.”, is displayed.

Even if the user moves while viewing 3D video content and the position of the user deviates from the optical position, the user can move back to the optimal position by confirming the message displayed on the LCD 17.

In the meantime, in the personal computer 10 (position adjustment program 112c), various messages are prepared in accordance with the relative relationship between the present position of the 3D glasses 30 and the optimal position, and a necessary message is selected and displayed, as needed. For example, there are messages corresponding to upward, downward, leftward and rightward directions relative to the optimal position (reference position), and messages corresponding to the distance between the present position and the optimal position. For example, an approximate distance, over which the user should move, may be calculated from the captured image, and the message corresponding to the distance may be selected in accordance with the calculated distance.

In the above description, the message corresponding to the relative relationship between the present position and the optimal position is displayed. Alternatively, a message corresponding to the state of the 3D glasses 30 may be displayed. For example, the leftward/rightward inclination of the 3D glasses 30 is detected from the captured image, and a message corresponding to this inclination is displayed. For instance, a message, such as “Optimal 3D video can be enjoyed if the glasses are disposed horizontal.”, is displayed when the 3D glasses 30 are inclined more than a predetermined reference value. The leftward/rightward inclination of the 3D glasses 30 can be detected by a conventional image process.

In this manner, in the personal computer 10 of the embodiment, even if the present position deviates from the optimal position while the 3D video content is being played back, a guidance as to how to adjust the position can be presented to the user by the message. Thereby, the user does not need to adjust the position, based on his/her own feeling alone, and the user can easily move to the optimal position and enjoy 3D video in good condition. In addition, since there is no need to process, e.g. 3D video content in accordance with the user's position, the processing load may be small.

In the above-described position adjustment process, the message is output while the 3D video content is being played back by the video playback program 112b. However, the position adjustment process may be executed prior to the playback of content, so that the message may not be displayed during the playback of 3D video content. The display of the message is stopped while the 3D video content is being played back. Thereby, it is possible to prevent the video from being hidden by the message window 17a while the 3D video content is being played back.

In the above description, the shape of the glasses used by the user is registered in advance by the 3D registration process. However, the 3D glasses registration process may be omitted by using characteristic 3D glasses 30 which can easily be detected in the position adjustment process. For example, an LED which is turned on in use is attached to the 3D glasses 30, and the 3D glasses 30 can be detected from the image, based on the position, color, etc. of the LED. The number of LEDs attached to the 3D glasses 30 may be one, or two or more. For example, two LEDs are provided at both ends of the 3D glasses 30, and thereby the leftward/rightward inclination of the 3D glasses 30 can also be easily detected.

Aside from the attachment of the LED to the 3D glasses 30, the 3D glasses 30 may be configured to have a characteristic shape or color so that the 3D glasses 30 can easily be detected by the image process.

In the above description, when the position of the 3D glasses is distant from the optimal position by a predetermined value or more, the LCD 17 displays the message for alerting the user. However, the user may be alerted by other output modes. For example, a light-emitting device, such as an LED, is provided on the personal computer 10, and the light-emitting device is turned on when the position of the 3D glasses 30 deviates from the optimal position, thus alerting the user. Thereby, the display of the 3D video content on the LCD 17 is not hindered. Besides, when the position of the 3D glasses 30 deviates from the optimal position, a specific sound may be produced to alert the user.

In the above description, the position of the 3D glasses 30 is simply detected from the image captured by the camera 21. Alternatively, the position of the 3D glasses 30 may be detected by using other kinds of sensors, and a message may be output. For example, the personal computer 10 is provided with a depth sensor, and the distance from the personal computer 10 (LCD 17) to the 3D glasses 30 is measured, thereby determining whether the 3D glasses 30 are at the optimal position for viewing the 3D video. A message corresponding to the determination result, such as “Please view, with a little more distance from the screen.”, is displayed. Other kinds of sensors may be used.

In the above description, for example, the case has been described in which a single pair of 3D glasses 30 are used, that is, a single user views 3D video content. However, two (or three or more) users may view 3D video content at the same time. In this case, for example, viewing by two persons is designated by a user operation. In the process of the position adjustment program 112c, the personal computer 10 sets the reference value, which is indicative of the difference between the present position and the optimal position, to be greater than in the case where a single user views 3D video content. Specifically, when two persons view the 3D video content, the present position may more easily deviate from the optimal position than in the case where a single person views the 3D video content. Thus, the range of tolerance, in which message display is needless, is increased so as to prevent frequent display of messages. Furthermore, the difference between the present position and the optimal position may be calculated with respect to each of plural pairs of 3D glasses 30, and thereby a message may be output with respect to each of the plural pairs of 3D glasses 30.

The various modules of the systems described herein can be implemented as software applications, hardware and/or software modules, or components on one or more computers, such as servers. While the various modules are illustrated separately, they may share some or all of the same underlying logic or code.

While certain embodiments have been described, these embodiments have been presented by way of example only, and are not intended to limit the scope of the inventions. Indeed, the novel embodiments described herein may be embodied in a variety of other forms; furthermore, various omissions, substitutions and changes in the form of the embodiments described herein may be made without departing from the spirit of the inventions. The accompanying claims and their equivalents are intended to cover such forms or modifications as would fall within the scope and spirit of the inventions.

What is claimed is:

1. A video display apparatus comprising:
a display device;
a camera configured to capture an image of glasses in front of the display device;
a detection module configured to detect a position of the glasses in the image;
a determination module configured to determine a relative relationship between the position detected by the detection module and a predetermined reference position; and
a message display module configured to cause the display device to display a message corresponding to the relative relationship.

2. The apparatus of claim 1, further comprising a video display module configured to display video on the display device,
wherein the message display module is configured to display the message while the video is being displayed.

3. The apparatus of claim 1, wherein the determination module is configured to detect an inclination of the glasses in the image based on the relative relationship, and
the message display module is configured to display a message corresponding to the inclination.

4. The apparatus of claim 1, wherein the determination module is configured to determine whether a distance between the position detected by the detection module and the reference position is at least a reference distance, and
the message display module is configured to display a message corresponding to the determination module determining that the distance between the position detected by the detection module and the reference position is at least the reference distance.

5. The apparatus of claim 4, further comprising a reference distance setting module configured to set the reference distance based on designation from a user.

6. A method comprising:
determining a relative relationship between a detected position of glasses in an image of the glasses in front of a display device; and
generating an output corresponding to the determined relative relationship,
wherein determining is performed by a computer processor.

7. A position assessment apparatus comprising a computing device comprising one or more processors, the computing device configured to:
determine a relative relationship between a detected position of glasses in an image and a predetermined reference position; and
generate output indicative of the relative relationship,
wherein the image is of glasses in front of a display device.
